(19) United States
(12) Patent Application Publication
(10) Pub. No.: US 2014/0274011 A1
(43) Pub. Date: Sep. 18, 2014

(54) METHOD AND APPARATUS FOR CONTROLLING OPERATION OF A USER EQUIPMENT BASED ON PHYSICAL LAYER PARAMETERS

(71) Applicant: QUALCOMM INCORPORATED, San Diego, CA (US)

(72) Inventors: Sachin Jain, Santa Clara, CA (US); Debesh Kumar Sahu, Hydrabad (IN); Subbarayudu Mutya, Hydrabad (IN); Navid Ehsan, San Diego, CA (US)

(73) Assignee: QUALCOMM Incorporated, San Diego, CA (US)

(21) Appl. No.: 13/804,218

(22) Filed: Mar. 14, 2013

(51) Int. Cl. H04W 8/22

(52) U.S. Cl. CPC H04W 8/22
USPC 455/418

(57) ABSTRACT

Techniques for controlling internal operation of a user equipment (UE) based on physical layer (PHY) parameters of a wireless network are disclosed. The PHY parameters may include a system bandwidth, an uplink-downlink configuration, a number of antennas, a number of carriers, etc. In one design, the UE may receive system information from the wireless network. The UE may obtain at least one PHY parameter of the wireless network, at a physical layer on the UE, based on the system information and/or other signaling. The UE may provide the at least one physical layer parameter to at least one entity (e.g., a memory and flow controller, a clock controller, a thermal mitigator, an application processor, etc.) within the UE for use to control internal operation of the UE.

### BACKGROUND

I. Field

The present disclosure relates generally to communication, and more specifically to techniques for controlling the operation of a user equipment (UE).

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless network may include a number of base stations that can support communication for a number of UEs. A UE may communicate with a base station via the downlink and uplink. The downlink (or forward link) refers to the communication link from the base station to the UE, and the uplink (or reverse link) refers to the communication link from the UE to the base station.

A wireless network may support flexible operation. For example, the wireless network may operate based on a system bandwidth selected from a set of possible system bandwidths. The configuration of the wireless network may impact communication between UEs and the wireless network.

### SUMMARY

A PHY parameter is a parameter that affects operation of a physical layer at a UE and a wireless network, and both would need to be aware of the PHY parameter. Some exemplary PHY parameters include a system bandwidth, an uplink-downlink configuration, a number of antennas, a number of carriers, etc.

In one design, a UE may receive system information from a wireless network. The UE may obtain at least one PHY parameter of the wireless network, at a physical layer on the UE, based on the system information and/or other signaling. The UE may provide the at least one physical layer parameter to at least one entity within the UE for use to control internal operation of the UE. Internal operation of the UE refers to operation of the UE that is transparent to the wireless network, e.g., operation that does not need to be reported to the wireless network.

In another design, the UE may provide the at least one physical layer parameter to a memory and flow controller for use to control at least one data buffer within the UE and/or to control at least one data flow within the UE. The UE may provide the at least one physical layer parameter to a clock controller for use to adjust clock rates for transmit tasks, receive tasks, and/or other tasks at the UE. The UE may provide the at least one physical layer parameter to a thermal mitigator for use for thermal mitigation at the UE. The UE may provide the at least one physical layer parameter to an application controller for use to control operation of at least one application running on the UE. The UE may also provide the at least one physical layer parameter to other entities for use to control other operations of the UE.

Various aspects and features of the disclosure are described in further detail below.

### BRIEF DESCRIPTION OF THE DRAWINGS

FIG. 1 shows a wireless communication network.

FIG. 2 shows exemplary protocol stacks.

FIGS. 3A and 3B show exemplary frame structures for frequency division duplexing (FDD) and time division duplexing (TDD), respectively.

FIG. 4 shows transmission of system information by a cell.

FIG. 5 shows a block diagram of a UE.

FIG. 6 shows memory and flow control based on PHY parameters.

FIG. 7 shows clock control based on PHY parameters.

FIG. 8 shows thermal mitigation based on PHY parameters.

FIG. 9 shows control of applications based on PHY parameters.

FIG. 10 shows a call flow for providing PHY parameters to entities.

FIGS. 11 and 12 show two processes for controlling internal operation of a UE based on PHY parameter.

FIG. 13 shows an exemplary implementation of an apparatus.

### DETAILED DESCRIPTION

The techniques described herein may be used for various wireless communication networks and radio access technologies. The terms “network” and “system” are often used interchangeably. For example, the techniques may be used for CDMA, TDMA, FDMA, OFDMA, SC-FDMA, and other wireless networks. Different wireless networks may implement different radio access technologies. For example, a CDMA network may implement a radio access technology such as Universal Terrestrial Radio Access (UTRA), cdma2000, etc. UTRA includes Wideband CDMA (WCDMA), Time Division Synchronous CDMA (TD-SCDMA), and other variants of CDMA. cdma2000 includes IS-2000, IS-95 and IS-856 standards. A TDMA network may implement a radio access technology such as Global System for Mobile Communications (GSM). An OFDMA network may implement a radio access technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA, E-UTRA and GSM are part of Universal Mobile Telecommunication System (UMTS). 3GPP Long Term Evolution (LTE) and LTE-Advanced (LTE-A) are recent releases of UMTS that use E-UTRA. UTRA, E-UTRA, GSM, UMTS, LTE and LTE-A are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio access technologies mentioned above as well as other wireless networks and radio access technologies. For clarity in description, certain aspects of the techniques are described below for LTE, and LTE terminology is used in much of the description below. It should be noted that other terminologies apply to other techniques and technologies.

FIG. 1 shows a wireless communication network 100, which may be an LTE network or some other wireless network. Wireless network 100 may include a number of evolved Node Bs (eNBs) 110 and other network entities. An eNB 110 may be a station or node that communicates with the UEs 120 and may also be referred to as a base station, a Node B, an access point, etc. Each eNB 110 may provide communication coverage for a particular geographic area and may support communication for the UEs located within the coverage area. To improve network capacity, the overall coverage area of an eNB 110 may be partitioned into multiple (e.g., three) smaller areas. Each smaller area may be served by a respective eNB 110 subsystem. In 3GPP, the term “cell” can refer to a coverage area of an eNB 110 and/or an eNB 110 subsystem serving this coverage area. In general, an eNB 110 may support one or multiple (e.g., three) cells.

A serving gateway 130 may perform various functions to support data communication for UEs 120. For example, serving gateway 130 may perform functions related to Internet Protocol (IP) data transfer for UEs 120 such as data routing and forwarding, mobility anchoring, etc. Serving gateway 130 may also perform various functions such as support for handover between eNBs 110, buffering, routing and forwarding of data for UEs 120, initiation of network-triggered service request procedures, accounting functions for charging, etc.

UEs 120 may be dispersed throughout the wireless network, and each UE 120 may be stationary or mobile. A UE 120 may also be referred to as a mobile station, a terminal, an access terminal, a subscriber unit, a station, etc. A UE 120 may be a cellular phone, a smartphone, a tablet, a wireless communication device, a personal digital assistant (PDA), a wireless modem, a handheld device, a laptop computer, a cordless phone, a wireless local loop (WLL) station, a netbook, a smartbook, etc.

A UE 120 may communicate with an eNB 110 and other network entities via various protocols designed to facilitate data transmission. Each protocol may perform a set of functions and may interface with one or more other protocols.

FIG. 2 shows exemplary protocol stacks for a user plane for communication between a UE and a serving gateway via an eNB. Each station/node may maintain a protocol stack for communication with another station/node. Each protocol stack typically includes a network layer (which is also referred to as Layer 3 or L3), a link layer (which is also referred to as Layer 2 or L2), and a physical layer (which is also referred to as Layer 1, L1, or PHY). The UE and the serving gateway may exchange data using IP at the network layer. Higher layer data may be encapsulated in IP packets, which may be exchanged between the UE and the serving gateway via the eNB.

The link layer may be dependent on network/radio access technology. For the user plane in LTE, the link layer for the UE includes three sublayers for Packet Data Convergence Protocol (PDCP), Radio Link Control (RLC), and Medium Access Control (MAC), which are terminated at the eNB. The UE further communicates with the eNB via E-UTRA air-link interface at the physical layer. The eNB may communicate with the serving gateway via IP and a technology-dependent interface for the link layer and the physical layer. In LTE, the link layer between the eNB and the serving gateway includes GPRS Tunneling Protocol for User Plane (GTP-U), User Datagram Protocol (UDP), IP, L2 and L1.

Wireless network 100 may utilize FDD and/or TDD. For FDD, the downlink and uplink are allocated separate frequencies, and downlink transmissions and uplink transmissions may be sent concurrently on the separate frequencies. For TDD, the downlink and uplink share the same frequency, and downlink and uplink transmissions may be sent on the same frequency in different time intervals.

FIG. 3A shows an exemplary frame structure 300 for FDD in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix (as shown in FIG. 3A) or six symbol periods for an extended cyclic prefix. The 2L symbol periods in each subframe may be assigned indices of 0 through 2L−1.

FIG. 3B shows an exemplary frame structure 350 for TDD in LTE. The transmission timeline for the downlink and uplink may be partitioned into units of radio frames, and each radio frame may be partitioned into 10 subframes with indices of 0 through 9. LTE supports a number of uplink-downlink configurations for TDD. Each uplink-downlink configuration indicates which subframes are used for the downlink and which subframes are used for the uplink. Subframes 0 and 5 are used for the downlink and subframe 2 is used for the uplink for all uplink-downlink configurations. Subframes 3, 4, 7, 8 and 9 may each be used for the downlink or uplink depending on the uplink-downlink configuration. Subframe 1 includes a Downlink Pilot Time Slot (DwPTS), a Guard Period (GP), and an Uplink Pilot Time Slot (UpPTS). Subframe 6 may include only the DwPTS, or all three special fields, or a downlink subframe depending on the uplink-downlink configuration.

Table 1 lists seven uplink-downlink configurations supported by LTE for TDD. Each uplink-downlink configuration indicates whether each subframe is a downlink subframe (denoted as “D” in Table 1), or an uplink subframe (denoted as “U” in Table 1), or a special subframe (denoted as “S” in Table 1). Uplink-downlink configuration 1 is symmetric and includes an equal number of downlink subframes and uplink subframes. Uplink-downlink configurations 2, 3, 4 and 5 are downlink heavy and include more downlink subframes than uplink subframes. Uplink-downlink configurations 0 and 6 are uplink heavy and include more uplink subframes than downlink subframes. An uplink-downlink configuration selected for use has an impact on throughput on the downlink as well as throughput on the uplink.

TABLE 1
Uplink-Downlink Configurations for TDD in LTE

| Uplink- | | | | | | | | | | |
|---|---|---|---|---|---|---|---|---|---|---|
| Downlink | Subframe Number n | | | | | | | | | |
| Configuration | 0 | 1 | 2 | 3 | 4 | 5 | 6 | 7 | 8 | 9 |
| 0 | D | S | U | U | U | D | S | U | U | U |
| 1 | D | S | U | U | D | D | S | U | U | D |
| 2 | D | S | U | D | D | D | S | U | D | D |
| 3 | D | S | U | U | U | D | D | D | D | D |
| 4 | D | S | U | U | D | D | D | D | D | D |
| 5 | D | S | U | D | D | D | D | D | D | D |
| 6 | D | S | U | U | U | D | S | U | U | D |

As shown in FIGS. 3A and 3B, a subframe for the downlink (i.e., a downlink subframe) may include a control region and a data region, which may be time division multiplexed (TDM). The control region may include the first Q symbol periods of the subframe, where Q may be equal to 1, 2, 3 or 4. Q may change from subframe to subframe and may be conveyed in the first symbol period of the subframe. The data region may include the remaining 2L−Q symbol periods of the subframe and may carry data and/or other information for UEs.

A cell may transmit downlink control information (DCI) on a Physical Downlink Control Channel (PDCCH) in the control region to one or more UEs. The DCI may include a downlink grant, an uplink grant, power control information, etc. The cell may transmit data and/or other information on a Physical Downlink Shared Channel (PDSCH) in the data region to one or more UEs. The cell may transmit a Physical Broadcast Channel (PBCH) in symbol periods 0 to 3 in slot 1 of subframe 0 in certain radio frames, as shown in FIGS. 3A and 3B. The PBCH may carry some system information.

A cell may transmit system information to convey various parameters used to support communication with UEs. In LTE, the system information may be partitioned into a master information block (MIB) and a number of system information blocks (SIBs) to enable efficient transmission and reception of the system information. The MIB may include a limited number of essential parameters used to acquire other information from the cell. The MIB may be transmitted periodically on the PBCH with a fixed schedule of 40 ms in subframe 0 of each radio frame for which (SFN mod 4)=0, where “mod” denotes a modulo operation.

Multiple (K) SIBs may be defined and may be referred to as system information block types 1 through K, or SIB1 through SIB K. In general, K may be any integer value, e.g., K=13 for LTE Release 10. Each SIB may carry a specific set of parameters to support operation by UEs. SIB1 may carry (i) scheduling information for N SI messages and (ii) a mapping of SIBs to SI messages, where N may be one or greater. The scheduling information may include the periodicity of each SI message and the time duration in which each SI message might be sent. The mapping may indicate which SIBs are sent in each SI message, with each SIB being sent in only one SI message. SIB1 and SI messages may be transmitted on the PDSCH. SIB1 may be transmitted at a periodicity of 80 ms in subframe 5 of each radio frame for which (SFN mod 8)=0. SIB1 may be partitioned into four parts and transmitted in subframe 5 of four even-numbered radio frames. SIB1 may thus be transmitted every 20 ms and may repeat every 80 ms.

FIG. 4 shows exemplary transmission of system information by a cell. The cell may transmit the MIB on the PBCH in subframe 0 of every radio frame. The periodicity of the MIB may thus be 10 ms. The cell may also transmit SIB1 on the PDSCH in subframe 5 of every other radio frame. The periodicity of SIB1 may thus be 20 ms. The cell may also transmit other SIBs on the PDSCH as scheduled for these SIBs. A UE may read the MIB and SIB1 from the cell based on their transmission schedule. The transmission schedule of the MIB and SIBs are cell specific and may vary from cell to cell.

A cell in a wireless network may broadcast various configurable physical layer (PHY) parameters that define the configuration of the cell. A PHY parameter is a parameter related to a physical layer and affects operation at the physical layer. For example, PHY parameters that are configurable may include the system bandwidth, the uplink-downlink configuration if TDD is utilized, the number carriers configured for a UE, the number of antennas at a cell, etc. The PHY parameters may be broadcast in system information and may be received by UEs to determine the configuration of the cell and/or the wireless network. The UEs may then operate in accordance with the configuration of the cell and/or the wireless network.

In LTE, the MIB includes a dl-Bandwidth parameter that indicates the system bandwidth. LTE supports six possible system bandwidths of 1.4, 3, 5, 10, 15 or 20 megahertz (MHz). The dl-Bandwidth indicates a specific system bandwidth used by a cell and/or a wireless network from among the six possible system bandwidths. The system bandwidth may have a large impact on peak throughput.

In LTE, SIB1 includes a tdd-Config information element (IE) that indicates an uplink-downlink configuration for a wireless network utilizing TDD. LTE supports the seven uplink-downlink configurations shown in Table 1. The tdd-Config information element includes a subframeAssignment parameter that indicates a specific uplink-downlink configuration used by the wireless network from among the seven supported uplink-downlink configurations.

Other PHY parameters defining the configuration of a cell and/or a wireless network may also be sent in the MIB, SIB1, or other SIBs. Each PHY parameter may be sent in the MIB or a specific SIB, which may be transmitted at a periodicity indicated by the scheduling information carried in SIB1.

In general, a cell and/or a wireless network may have various configurable PHY parameters such as system bandwidth, uplink-downlink configuration, number of carriers, number of antennas, etc. The PHY parameters may be conveyed in system information and/or other signaling. Different system bandwidths, different uplink-downlink configurations, different numbers of carriers, and different numbers of antennas can support different throughputs for a UE.

In an aspect of the present disclosure, a UE may control and improve its operation based on PHY parameters obtained from a cell in a wireless network. The UE may receive system information broadcast by the cell and obtain the PHY parameters. The UE may provide the PHY parameters to one or more entities within the UE. Each entity may control certain operation of the UE such that good performance can be achieved.

FIG. 5 shows an exemplary functional block diagram of a design of a UE 120x, which may be one of UEs 120 in FIG. 1. Within UE 120x, an antenna 510 may receive downlink signals from eNBs and/or other stations and may provide a received radio frequency (RF) signal to a receiver 512. Receiver 512 may process (amplify, filter, and downconvert) the received RF signal and provides an analog input signal to a PHY/modem processor 520. PHY/modem processor 520 may digitize the analog input signal to obtain input samples and may perform processing for the physical layer, which may be dependent on the radio access technology utilized by the wireless network. A receive (RX) processor 522 may demodulate the input samples (e.g., for OFDM, CDMA, etc.) to obtain received symbols and may further decode the received symbols to obtain decoded data.

A processing module 530 may process (e.g., descramble, decompress, etc.) the decoded data from PHY/modem processor 520. Processing module 530 may perform processing for layers above the physical layer. Processing module 530 may also perform functions and tasks normally not associated with the PHY layer, as described below.

For data transmission, processing module 530 may process data to be transmitted and provide output data to PHY/modem processor 520. Within PHY/modem processor 520, a transmit (TX) processor 524 may process (e.g., encode and modulate) the output data to obtain output samples. PHY/modem processor 520 may further convert the output samples to an analog output signal. A transmitter 514 may process (e.g., amplify, filter, and upconvert) the analog output signal to obtain an output RF signal, which may be transmitted via antenna 510 to eNBs and/or other stations.

In the design shown in FIG. 5, a system information reception processor 526 within PHY/modem processor 520 may process the decoded data (e.g., for the PBCH and PDSCH) to obtain system information sent by eNBs and/or other stations. Processor 526 may obtain PHY parameters from the received system information and may provide the PHY parameters to processing module 530. The PHY parameters may comprise the system bandwidth, the uplink-downlink configuration, the number of carriers, the number of antennas, other PHY parameters, or a combination thereof.

In the design shown in FIG. 5, processing module 530 includes various entities that perform different functions for UE 120x. Processing module 530 may receive the PHY parameters from PHY/modem processor 520 and may provide the PHY parameters to a memory and flow controller 540, a clock controller 550, a thermal mitigator 560, an application controller 570, and/or other entities within processing module 530. Memory and flow controller 540 may perform memory and flow control based on the PHY parameters. For example, controller 540 may determine the sizes of data buffers 542, used to store data passed between layers of a protocol stack at UE 120x, based on the PHY parameters. Controller 540 may also direct a flow controller 544 to control the flow of data passed between protocol layers based on the PHY parameters. Clock controller 550 may control the rates of clocks for transmit and receive tasks based on the PHY parameters. For example controller 550 may direct a clock generator 552 to generate clocks at suitable rates based on the PHY parameters. Thermal mitigator 560 may receive the temperature sensed by a temperature sensor 562 and may determine which tasks to reduce or cut based on the PHY parameters when high temperature is sensed. Application controller 570 may control the operation of an application processor 572 based on the PHY parameters. Processor 572 may execute upper-layer applications 574 running at UE 120x.

A data processor/controller 580 may perform various functions for UE 120x. For example, data processor 580 may perform processing for data being transmitted and data being received by UE 120x. Controller 580 may control the operation of various processors, controllers, and other units within PHY/modem processor 520 and processing module 530. A memory 582 may store program codes and data for data processor/controller 580. The various processors and modules within UE 120x may communicate via a bus 590. Data processor/controller 580, memory 582, PHY/modem processor 520, and processing module 530 may be implemented on one or more application specific integrated circuits (ASICs) and/or other ICs.

As noted earlier, FIG. 5 illustrates an exemplary functional block diagram of a UE. The processors, controllers, generators, and other blocks in FIG. 5 may be implemented in various manners. For example, a UE may include an ASIC, one or more memories coupled to the ASIC, and one or more radio frequency integrated circuits (RFICs) coupled to the ASIC. The ASIC may include a digital signal processor (DSP), an advanced RISC machine (ARM) processor, a central processing unit (CPU), and/or one or more other processors. PHY/modem processor 520, RX processor 522, TX processor 524, and system information reception processor 526 may be implemented by the DSP within the ASIC. Each controller, each processor, and thermal mitigator 560 within processing module 530 and also processor/controller 580 may be implemented by the modem processor, or the ARM processor, or the CPU, or some other processor within the ASIC. Clock generator 552 and temperature sensor 562 may be implemented by circuit blocks within the ASIC or the RFIC(s). Data buffers 542 may be implemented by one or more memories internal to the ASIC and/or one or more memories external to the ASIC. Applications 574 may comprise software code, which may be stored in one or more memories internal and/or external to the ASIC. Receiver 512 and transmitter 514 may be implemented by the RFIC(s). A UE may also include different and/or other processors, controllers, and blocks not shown in FIG. 5. The processors, controllers, and blocks of a UE may also be implemented in other manners different from the exemplary design described above.

FIG. 6 shows a design of memory and flow control at UE 120x for uplink transmission based on PHY parameters. UE 120x may have M active applications 574 running at UE 120x, where M≧1. The M applications 574 may be for voice, video, data download, Web browsing, games, location positioning, etc. The M applications 574 may have data to send and may pass/push the data down to a data service layer (DSL) 620 for transmission to a wireless network. DSL 620 may implement various protocols such as TCP/UDP, IP, PDCP and RLC and may process the data from applications 574 for the supported protocols. In one design that is shown in FIG. 6, DSL 620 may include a data buffer for each supported protocol, e.g., a data buffer 630a for IP, a data buffer 630b for PDCP, and a data buffer 630c for RLC. Data buffers 630a to 630c may be part of data buffers 542 in FIG. 5. In another design, DSL 620 may include a data buffer that may be shared by all supported protocols. Data buffering may also be supported in other manners in DSL 620.

A watermark controller 640 may receive the PHY parameters and may determine at least one watermark for each data buffer 630 in DSL 620. Watermark controller 640 may be part of memory and flow controller 540 in FIG. 5. A watermark may be a target queue size for a data buffer. In one design, watermark controller 640 may determine a high watermark and a low watermark for each data buffer 630 based on the PHY parameters. The high watermark may correspond to an upper queue size, and the low watermark may correspond to a lower queue size. DSL 620 may not accept data from applications 574 when the amount of data in a given data buffer 630 exceeds the high watermark. DSL 620 may start accepting data from applications 574 when the amount of data in the given data buffer 630 falls below the low watermark. For example, a given data buffer 630 may have a size of K bytes. The high watermark may be set at 90% of K bytes, and the low watermark may be set at 70% of K bytes. The high and low watermarks may also be set to other values. The high and low watermarks may provide hysteresis in order to avoid continually switching between accepting and rejecting data from applications 574.

In another design, watermark controller 640 may determine a single watermark for each data buffer 630 based on the PHY parameters. DSL 620 may not accept data from applications 574 when the amount of data in a given data buffer 630 exceeds the watermark. DSL 620 may accept data from applications 574 when the amount of data in the given data buffer 630 falls below the watermark.

In one design, watermark controller 640 may determine at least one watermark based on the PHY parameters. A higher watermark may be used for a wider system bandwidth (e.g., 20 MHz). Conversely, a lower watermark may be used for a more narrow system bandwidth (e.g., 1.4 MHz). In another design, watermark controller 640 may determine at least one watermark based on the uplink-downlink configuration. A higher uplink watermark may be used for an uplink-downlink configuration having more uplink subframes (e.g., uplink-downlink configuration 0 having six uplink subframes). Conversely, a lower uplink watermark may be used for an uplink-downlink configuration having fewer uplink subframes (e.g., uplink-downlink configuration 5 having one uplink subframe). In yet another design, watermark controller 640 may determine at least one watermark based on the number of carriers configured for UE 120. A higher watermark may be used for more carriers (e.g., five carriers). A lower watermark may be used for fewer carriers (e.g., one carrier). Watermark controller 640 may also determine at least one watermark based on any combination of the system bandwidth, the uplink-downlink configuration, the number of carriers configured for UE 120x, the number of antennas at a serving eNB, etc.

Conventionally, watermarks are set based on the largest system bandwidth of 20 MHz and uplink-downlink configuration 0 with the most number of uplink subframes. However, setting the watermarks based on the highest possible throughput on the uplink may result in sub-optimal performance for other network configurations. In particular, setting the watermarks too high may result in larger buffer sizes and may increase latency if the outflow is not fast enough. Conversely, setting the watermarks too low may result in smaller buffer sizes and may cause radio resources to be under-utilized. Setting the watermarks of data buffers 630 based on the PHY parameters, as described above, may improve performance.

Flow controller 554 may receive the PHY parameters and may generate controls for flows of different protocols (e.g., IP, PDCP and RLC) within data service layer 620. Data may be processed as flows within data service layer 620. A flow may refer to a stream of packets exchanged between a UE and an eNB. Flow controller 554 may generate controls for the flows based on the system bandwidth, the uplink-downlink configuration, the number of carriers, the number of antennas, etc. For example, flow controller 554 may generate control to increase the data rate or the throughput of a flow due to a wider system bandwidth, an uplink-downlink configuration with more uplink subframes, more carriers, more antennas, etc. Flow controller 554 may also redistribute resources to the flows based on the PHY parameters. For example, when the system bandwidth is narrow, flow controller 554 may ensure that a flow carrying control information can meet minimum requirements while reducing flows for traffic data and/or other information.

FIG. 6 shows a design of memory and flow control for uplink transmission based on PHY parameters. Memory and flow control may also be performed for downlink transmission based on PHY parameters. A downlink data buffer may store data to pass up to applications 574 running at UE 120x. Watermark controller 640 may generate one or more watermarks for the downlink data buffer based on the PHY parameters. A higher watermark may be used for the downlink data buffer for a wider system bandwidth, an uplink-downlink configuration having more downlink subframes, more carriers configured for UE 120x, more antennas at the serving eNB, etc. Conversely, a lower watermark may be used for the downlink data buffer for a more narrow system bandwidth, an uplink-downlink configuration having fewer downlink subframes, fewer carriers configured for UE 120x, fewer antennas at the serving eNB, etc.

FIG. 7 shows a design of clock control based on PHY parameters. Clock controller 550 may receive the PHY parameters and may select suitable clock rates based on the PHY parameters. Clock generator 552 may receive the selected clock rates and may generate receive (RX) clocks and transmit (TX) clocks at the selected clock rates. Clock generator 552 may provide the RX clocks to RX processor 522 and may provide the TX clocks to TX processor 524. Clock generator 552 may also generate other TX clocks for other TX tasks, other RX clocks for other RX tasks, and/or other clocks for other modules or circuits within UE 120x.

In one design, clock controller 550 may select clock rates based on the system bandwidth. Faster clocks may be generated for a wider system bandwidth, and slower clocks may be generated for a more narrow system bandwidth. In another design, clock controller 550 may select clock rates based on the uplink-downlink configuration. Faster TX clocks may be generated for more uplink subframes (e.g., in uplink-downlink configuration 0), and slower TX clocks may be generated for fewer uplink subframes (e.g., in uplink-downlink configuration 5). Faster RX clocks may be generated for more downlink subframes (e.g., in uplink-downlink configuration 5), and slower RX clocks may be generated for fewer downlink subframes (e.g., in uplink-downlink configuration 0). In yet another design, clock controller 550 may select clock rates based on the number of carriers configured for UE 120. Faster clocks may be generated for more carriers, and slower clocks may be generated for fewer carriers. In yet another design, clock controller 550 may select clock rates based on the number of antennas at the serving eNB. Faster clocks may be generated for more antennas, and slower clocks may be generated for fewer antennas. Clock controller 550 may select the clock rates for the TX clocks and/or the RX clocks based on any combination of the system bandwidth, the uplink-downlink configuration, the number of carriers configured for UE 120x, the number of antennas at a serving eNB, etc. Different clock rates may also be used for different tasks.

Conventionally, TX clocks and RX clocks are set based on the highest expected throughput on the uplink and downlink, respectively. This may coincide with the largest system bandwidth. The TX clocks may be set based further on uplink-downlink configuration 0 with the most uplink subframes. The RX clocks may be set based further on uplink-downlink configuration 5 with the most downlink subframes. Setting the TX clocks and RX clocks in this manner may ensure that these clocks are sufficiently fast even in the worst-case scenarios. However, setting the TX clocks and RX clocks based on the worst-case scenarios may result in excessively fast TX clocks and RX clocks in other scenarios. Controlling the clock rates of the TX clocks and/or the RX clocks based on the PHY parameters, as described above, may reduce power consumption, extend battery life, and provide other benefits.

FIG. 8 shows a design of thermal mitigation based on PHY parameters. Temperature sensor 562 may sense the temperature within UE 120x. Thermal mitigator 560 may receive the sensed temperature from temperature sensor 562, the PHY parameters from PHY/modem processor 520, the current activity levels of M active applications 574 on UE 120x, the current downlink (DL) data rate, the current uplink (UL) data rate, some other inputs, or a combination thereof. Thermal mitigator 560 may determine whether high temperature has been detected. If high temperature is detected, then thermal mitigator 560 may initiate one or more remedial actions in order to reduce the temperature of UE 120x. Thermal mitigation may be performed in various manners.

In one design, thermal mitigator 560 may compare the sensed temperature against a single threshold. If the sensed temperature is higher than the threshold, then thermal mitigator 560 may initiate one or more remedial actions. In another design, thermal mitigator 560 may compare the sensed temperature against multiple thresholds and may initiate different remedial actions when the sensed temperature exceeds different thresholds. For example, the sensed temperature may be compared against a regular threshold, a critical threshold, and a danger threshold. Thermal mitigator 560 may initiate progressively more remedial actions and/or may perform the remedial actions more aggressively (e.g., reduce data rate more) in response to the sensed temperature exceeding progressively higher thresholds.

Various remedial actions may be performed based on the PHY parameters in order to reduce temperature of UE 120x. In one design, clock rates of TX clocks, RX clocks, and/or other clocks may be reduced in order to reduce power dissipation and lower the temperature of UE 120x. The clocks may be reduced based on the system bandwidth, the uplink-downlink configuration, the number of carriers, the number of antennas, etc. For example, the clock rates may be reduced more for a more narrow system bandwidth or reduced less for a wider system bandwidth in order to ensure that the clocks are sufficient fast for the system bandwidth.

In another design, applications and/or tasks requiring more central processing unit (CPU) may be identified based on their activity levels, their throughputs, and/or other criteria. One or more applications and/or tasks requiring more CPU may have their activity level or throughput reduced in order to lower the temperature of UE 120x. For example, the throughput or data rate of an application or a task requiring high CPU may be reduced when the system bandwidth is wide or may be cut when the system bandwidth is narrow.

In yet another design, the data rate of the uplink and/or the data rate of the downlink may be reduced based on the PHY parameters. For example, when high temperature is detected, the data rate on the uplink may be reduced when uplink-downlink configuration 0 with more uplink subframes than downlink subframes is utilized. The data rate on the downlink may be reduced when uplink-downlink configuration 5 with more downlink subframes than uplink subframes is utilized. Other remedial actions may also be performed in order to reduce the temperature of UE 120x.

Thermal mitigator 560 may generate various controls to reduce the temperature of UE 120x when high temperature is sensed. In one design, thermal mitigator 560 may generate controls to reduce the TX clocks, the RX clocks, and/or other clocks when high temperature is sensed. In another design, thermal mitigator 560 may generate controls to reduce the activity levels of one or more applications and/or tasks when high temperature is sensed. In yet another design, thermal mitigator 560 may generate controls to reduce the uplink data rate and/or the downlink data rate when high temperature is sensed. Thermal mitigator 560 may also generate controls for other remedial actions and/or a combination of remedial actions.

FIG. 9 shows a design of controlling applications based on PHY parameters. Application controller 570 may receive the PHY parameters from PHY/modem processor 520 and may generate controls for processors 572a to 572m for M active applications 574 running on UE 120x. Processors 572a to 572m may be part of application processor 572 in FIG. 5 and may perform processing for the M active applications. Each application may have one or more configurable settings or parameters, which may be dependent on the type of application. In one design, a video application may support a set of video formats of different resolutions, and a suitable video format may be selected based on the system bandwidth. For example, a high-resolution format may be selected for a large system bandwidth, and a low-resolution format may be selected for a more narrow system bandwidth. In another design, an audio application may support a set of coding/decoding (codec) rates, and a suitable codec rate may be selected based on the system bandwidth and/or other PHY parameters. In yet another design, a Web browser may support a set of download rates, and a suitable download rate may be selected based on the system bandwidth and/or other PHY parameters. Other applications may have other settings, which may be selected based on the PHY parameters.

Controlling applications based on the PHY parameters may improve performance. In particular, applications may be executed with settings selected based on the PHY parameters (e.g., the system bandwidth and uplink-downlink configuration) so that the applications can provide good output and still be supported by UE 120x.

FIG. 10 shows a design of a call flow 1000 for controlling the internal operation of UE 120x based on PHY parameters. UE 120x may be powered on (step 1012). The PHY layer of UE 120x (e.g., PHY/modem processor 520 in FIG. 2) may perform system acquisition upon being powered on (step 1014). The PHY layer may receive system information, which may be sent in the MIB, SIB1, and other SIBs (step 1016). The PHY layer may obtain PHY parameters such as the system bandwidth, the uplink-downlink configuration, the number of antennas, etc. from the system information (step 1018). The PHY layer may also obtain the number of carriers configured for UE 120x based on RRC signaling and/or other signaling. The PHY layer may determine whether the PHY parameters have changed (step 1020). If the PHY parameters have changed, then the PHY layer may provide the PHY parameters to interested entities or clients within UE 120x such as memory and flow controller 540, clock controller 550, thermal mitigator 560, and/or application controller 570 (step 1022). Each entity/client may operate based on the PHY parameters and may control certain operation of UE 120x based on the PHY parameters, as described above (step 1024). The PHY layer may periodically perform steps 1016 to 1022, e.g., whenever the system information is transmitted or changed.

The techniques described herein may provide various advantages. First, the techniques may enable efficient use of resources at a UE to achieve good results based on PHY parameters. The techniques may improve data throughput, reduce power consumption, and provide better control of situations in case of bad network conditions. The techniques may be used for various wireless networks such as LTE, UMTS, CDMA 1X, GSM, and other wireless networks.

FIG. 11 shows a design of a process 1100 for controlling internal operation of a UE. Process 1100 may be performed by the UE (as described below) or by some other entity. The UE may receive system information (e.g., MIB, SIB1, etc.) from a wireless network (block 1112). The UE may obtain at least one physical layer parameter of the wireless network, at a physical layer on the UE, based on the system information and/or other signaling (block 1114). The at least one physical layer parameter may comprise a system bandwidth, an uplink-downlink configuration for TDD, a number of antennas at a cell in the wireless network, a number of carriers configured for the UE, some other physical layer parameter, or a combination thereof. The UE may provide the at least one physical layer parameter to at least one entity within the UE for use to control internal operation of the UE (block 1116).

FIG. 12 shows an exemplary design of a process 1200 for controlling internal operation of a UE based on at least one physical layer parameter. Process 1200 may be performed by the UE and may be used for block 1116 in FIG. 11. The UE may provide the at least one physical layer parameter to a first entity (e.g., memory and flow controller 540 in FIG. 5) for use to control at least one data buffer within the UE (block 1212). At least one watermark for the at least one data buffer within the UE may be generated based on the at least one physical layer parameter. The UE may provide the at least one physical layer parameter to a second entity (e.g., memory and flow controller 540 in FIG. 5) for use to control at least one data flow within the UE (block 1214).

The UE may provide the at least one physical layer parameter to a third entity (e.g., clock controller 550 in FIG. 5) for use to adjust clock rates for transmit tasks and/or receive tasks at the UE (block 1216). A transmit clock may be generated at a first clock rate, which may be determined based on the at least one physical layer parameter. A receive clock may be generated at a second clock rate, which may be determined based on the at least one physical layer parameter.

The UE may provide the at least one physical layer parameter to a fourth entity (e.g., thermal mitigator 560 in FIG. 6) for use for thermal mitigation at the UE (block 1218). The temperature of the UE may be sensed. In one design, a clock may be generated at a rate that may be determined based on the sensed temperature and the at least one physical layer parameter. In another design, an activity level of an application running on the UE may be controlled based on the sensed temperature and the at least one physical layer parameter. In yet another design, an uplink data rate and/or a downlink data rate of the UE may be controlled based on the sensed temperature and the at least one physical layer parameter. Other remedial actions may also be performed based on the sensed temperature and the at least one physical layer parameter for thermal mitigation.

The UE may provide the at least one physical layer parameter to a fifth entity (e.g., application controller 570 in FIG. 5) for use to control operation of at least one application running on the UE (block 1220). A setting of an application running on the UE may be selected based on the at least one physical layer parameter. The UE may provide the at least one physical layer parameter to other entities for use to control other operation of the UE.

FIG. 13 shows part of a hardware implementation of an apparatus 1300, which may be able to perform process 1000 in FIG. 10, process 1100 in FIG. 11, and/or process 1200 in FIG. 12. Apparatus 1300 includes circuitry and may be one configuration of a user entity (e.g., a UE) or some other entity. In this specification and the appended claims, the term “circuitry” is construed as a structural term and not as a functional term. For example, circuitry may be an aggregate of circuit components, such as a multiplicity of integrated circuit components, in the form of processing and/or memory cells, units, blocks and the like, such as shown and described in FIG. 13.

Apparatus 1300 comprises a central data bus 1302 linking several circuits together. The circuits include at least one processor 1304, a receive circuit 1306, a transmit circuit 1308, and a memory 1310. Memory 1310 is in electronic communication with processor(s) 1304, so that processor(s) 1304 may read information from and/or write information to memory 1310. Processor(s) 1304 may comprise a general purpose processor, a central processing unit (CPU), a microprocessor, a digital signal processor (DSP), a controller, a microcontroller, a state machine, an application specific integrated circuit (ASIC), a programmable logic device (PLD), a field programmable gate array (FPGA), etc. Processor(s) 1304 may comprise a combination of processing devices, e.g., a combination of a DSP and a microprocessor, a plurality of microprocessors, one or more microprocessors in conjunction with a DSP core, or any other such configuration.

Receive circuit 1306 and transmit circuit 1308 may be connected to a radio frequency (RF) circuit (not shown in FIG. 13). Receive circuit 1306 may process and buffer received signals before sending the signals out to data bus 1302. Transmit circuit 1308 may process and buffer data from data bus 1302 before sending the data out of apparatus 1300. Processor(s) 1304 may perform the function of data management of data bus 1302 and further the function of general data processing, including executing the instructional contents of memory 1310. Transmit circuit 1308 and receive circuit 1306 may be external to processor(s) 1304 (as shown in FIG. 13) or may be part of processor(s) 1304.

Memory 1310 stores a set of instructions 1312 executable by processor(s) 1304 to implement the methods described herein. To implement process 1100 in FIG. 11, instructions 1312 may include code 1322 for receiving system information (e.g., MIB, SIB1, etc.) from a wireless network, code 1324 for obtaining at least one physical layer parameter of the wireless network, at a physical layer on the UE, based on the system information and/or other signaling, and code 1326 for providing the at least one physical layer parameter to at least one entity within the UE for use to control internal operation of the UE. To implement process 1200 in FIG. 12, instructions 1312 may include code 1328 for providing the at least one physical layer parameter to a first entity for use to control at least one data buffer within the UE, code 1330 for providing the at least one physical layer parameter to a second entity for use to control at least one data flow within the UE, code 1332 for providing the at least one physical layer parameter to a third entity for use to adjust clock rates for transmit tasks and/or receive tasks at the UE, code 1334 for providing the at least one physical layer parameter to a fourth entity for use for thermal mitigation at the UE, and code 1336 for providing the at least one physical layer parameter to a fifth entity for use to control operation of at least one application running on the UE. Instructions 1312 may include different and/or other codes for other functions.

Instructions 1312 shown in memory 1310 may comprise any type of computer-readable statement(s). For example, instructions 1312 in memory 1310 may refer to one or more programs, routines, sub-routines, modules, functions, procedures, data sets, etc. Instructions 1312 may comprise a single computer-readable statement or many computer-readable statements.

Memory 1310 may be a RAM (Random Access Memory) circuit. Memory 1310 may be tied to another memory circuit (not shown), which may either be of a volatile or a nonvolatile type. As an alternative, memory 1310 may be made of other circuit types, such as an EEPROM (Electrically Erasable Programmable Read Only Memory), an EPROM (Electrical Programmable Read Only Memory), a ROM (Read Only Memory), an ASIC (Application Specific Integrated Circuit), a magnetic disk, an optical disk, and others well known in the art. Memory 1310 may be considered to be an example of a computer-program product that comprises a computer-readable medium with instructions 1312 stored therein.

As noted earlier, FIG. 13 illustrates an exemplary hardware design of a UE. The processor(s), memory, and circuits in FIG. 13 may be implemented in various manners. For instance, the various processors and controllers as shown in the functional block diagram of FIG. 5 may be architecturally grouped as processor 1304. Algorithms related to the functional block diagram of FIG. 5 may be programmed into memory 1310 as previously described. Again, it should be emphasized that the hardware implemented as shown in FIG. 13 is merely an example. Other implementations are clearly possible.

The previous description of the disclosure is presented to enable any person skilled in the art to make and use the disclosure. Details are set forth in the previous description for purpose of explanation. It should be appreciated that one of ordinary skill in the art would realize that the disclosure may be practiced without the use of these specific details. In other instances, well-known structures and processes are not elaborated in order not to obscure the description of the disclosure with unnecessary details. Thus, the present invention is not intended to be limited by the examples and designs described herein, but is to be accorded with the widest scope consistent with the principles and features disclosed herein.

The functions described herein may be implemented in hardware, software, firmware, or any combination thereof. If implemented in software, the functions may be stored as one or more instructions on a computer-readable medium. The term “computer-readable medium” or “computer program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the networks, methods, and apparatus described herein without departing from the scope of the claims.

No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
obtaining at least one physical layer parameter of a wireless network at a physical layer on a user equipment; and
providing the at least one physical layer parameter to at least one entity within the user equipment for use to control internal operation of the user equipment.

2. The method of claim 1, wherein providing the at least one physical layer parameter comprises providing the at least one physical layer parameter to an entity for use to control at least one data buffer within the user equipment.

3. The method of claim 1, further comprising:
generating at least one watermark for at least one data buffer within the user equipment based on the at least one physical layer parameter.

4. The method of claim 1, wherein the providing the at least one physical layer parameter comprises providing the at least one physical layer parameter to an entity for use to control at least one data flow within the user equipment.

5. The method of claim 1, wherein the providing the at least one physical layer parameter comprises providing the at least one physical layer parameter to an entity for use to adjust clock rates for transmit tasks, or receive tasks, or both at the user equipment.

6. The method of claim 1, further comprising:
generating a transmit clock at a first clock rate determined based on the at least one physical layer parameter; and
generating a receive clock at a second clock rate determined based on the at least one physical layer parameter.

7. The method of claim 1, wherein the providing the at least one physical layer parameter comprises providing the at least one physical layer parameter to an entity for use for thermal mitigation at the user equipment.

8. The method of claim 1, further comprising:
sensing temperature of the user equipment; and
generating a clock at a rate determined based on the sensed temperature and the at least one physical layer parameter.

9. The method of claim 1, further comprising:
sensing temperature of the user equipment; and
controlling an activity level of an application running on the user equipment based on the sensed temperature and the at least one physical layer parameter.

10. The method of claim 1, further comprising:
sensing temperature of the user equipment; and
controlling an uplink data rate, or a downlink data rate, or both of the user equipment based on the sensed temperature and the at least one physical layer parameter.

11. The method of claim 1, wherein the providing the at least one physical layer parameter comprises providing the at least one physical layer parameter to an entity for use to control operation of at least one application running on the user equipment.

12. The method of claim 1, further comprising:
selecting a setting of an application running on the user equipment based on the at least one physical layer parameter.

13. The method of claim 1, further comprising:
receiving system information from the wireless network; and
obtaining the at least one physical layer parameter from the system information.

14. The method of claim 1, wherein the at least one physical layer parameter comprises a system bandwidth, or an uplink-downlink configuration for time division duplexing, or a number of antennas at a cell in the wireless network, or a number of carriers configured for the user equipment, or a combination thereof.

15. An apparatus for wireless communication, comprising:
means for obtaining at least one physical layer parameter of a wireless network at a physical layer on a user equipment; and
means for providing the at least one physical layer parameter to at least one entity within the user equipment for use to control internal operation of the user equipment.

16. The apparatus of claim 15, wherein the means for providing the at least one physical layer parameter comprises means for providing the at least one physical layer parameter to an entity for use to control at least one data buffer within the user equipment.

17. The apparatus of claim 15, wherein the means for providing the at least one physical layer parameter comprises means for providing the at least one physical layer parameter to an entity for use to control at least one data flow within the user equipment.

18. The apparatus of claim 15, wherein the means for providing the at least one physical layer parameter comprises means for providing the at least one physical layer parameter to an entity for use to adjust clock rates for transmit tasks, or receive tasks, or both at the user equipment.

19. The apparatus of claim 15, wherein the means for providing the at least one physical layer parameter comprises means for providing the at least one physical layer parameter to an entity for use for thermal mitigation at the user equipment.

20. The apparatus of claim 15, wherein the means for providing the at least one physical layer parameter comprises means for providing the at least one physical layer parameter to an entity for use to control operation of at least one application running on the user equipment.

21. An apparatus for wireless communication, comprising:
circuitry configured to:
obtain at least one physical layer parameter of a wireless network at a physical layer on a user equipment; and
provide the at least one physical layer parameter to at least one entity within the user equipment for use to control internal operation of the user equipment.

22. The apparatus of claim 21, wherein the circuitry is configured to provide the at least one physical layer parameter to an entity for use to control at least one data buffer within the user equipment.

23. The apparatus of claim 21, wherein the circuitry is configured to provide the at least one physical layer parameter to an entity for use to control at least one data flow within the user equipment.

24. The apparatus of claim 21, wherein the circuitry is configured to provide the at least one physical layer parameter to an entity for use to adjust clock rates for transmit tasks, or receive tasks, or both at the user equipment.

25. The apparatus of claim 21, wherein the circuitry is configured to provide the at least one physical layer parameter to an entity for use for thermal mitigation at the user equipment.

26. The apparatus of claim 21, wherein the circuitry is configured to provide the at least one physical layer parameter to an entity for use to control operation of at least one application running on the user equipment.

27. A computer program product, comprising:
a non-transitory computer-readable medium comprising:
code for causing at least one computer to obtain at least one physical layer parameter of a wireless network at a physical layer on a user equipment; and
code for causing the at least one computer to provide the at least one physical layer parameter to at least one entity within the user equipment for use to control internal operation of the user equipment.
